(19) United States
(12) Patent Application Publication
(10) Pub. No.: US 2017/0154311 A1
(43) Pub. Date: Jun. 1, 2017

(54) RECOMMENDING POSITION QUALIFICATIONS

(71) Applicant: Linkedln Corporation, Mountain View, CA (US)

(72) Inventors: Monica Marie Lewis, Menlo Park, CA (US); Christina Lynn Lopus, San Francisco, CA (US); Xianren Wu, Santa Clara, CA (US); Prashanth Govindarajan, San Jose, CA (US); Eduardo Vivas, Miami, FL (US)

(21) Appl. No.: 15/056,969

(22) Filed: Feb. 29, 2016

Related U.S. Application Data
(60) Provisional application No. 62/261,143, filed on Nov. 30, 2015.

(51) Int. Cl. G06Q 10/10

(52) U.S. Cl. CPC G06Q 10/1053

(57) ABSTRACT

This disclosure relates to systems and methods for recommending qualifications for an available position. In one example, a method includes receiving user input that identifies an available position, generating a set of qualifications for the available position by determining qualifications that are included in one or more user profiles at an online social networking service, the user profiles for persons who currently hold a position at a location of the available position and similar to the available position, and recommending the set of qualifications to be included in a description of the available position.

### RELATED APPLICATIONS

This application claims the priority benefit of U.S. Provisional Application No. 62/261,143, entitled “RECOMMENDING POSITION QUALIFICATIONS,” filed Nov. 30, 2015 which is hereby incorporated herein by reference in its entirety.

### TECHNICAL FIELD

The subject matter disclosed herein generally relates to personnel management and, more particularly, to a system that identifies qualifications appropriate for an available position and recommends identified position qualifications.

### BACKGROUND

As technology advances, corporate employment needs frequently change. In response to needing additional employees, a company may submit a description of an available employment position to an employment service. However, in many circumstances, the company may not be able to adequately describe the available position or may include in its description qualifications that are not likely to draw appropriate candidates into the hiring pool. In one example, the position needs specialized skills and/or experience. In another example, the individual submitting the description on behalf of the company simply doesn't have the experience to generate an accurate list of qualifications. In one example, the individual submitting the description is a human resources manager, and the available position is for a chemical engineer. In this example, the human resources manager may not know specific details regarding the qualifications for the engineering position.

In one example, a system provides a prewritten description of an available position based on a title of the position. However, due to variations in similar positions at different locations, in different industries, or in other different contexts, the prewritten description may not accurately describe the available position.

### BRIEF DESCRIPTION OF THE DRAWINGS

Some embodiments are illustrated by way of example and not limitation in the figures of the accompanying drawings.

FIG. 1 is a block diagram illustrating various components or functional modules of an online social networking service, in an example embodiment.

FIG. 2 is a block diagram illustrating a system for recommending position qualifications, according to one example embodiment.

FIG. 3 is a block diagram illustrating another system for recommending position qualifications, according to one example embodiment.

FIG. 4 is a flow chart diagram illustrating a method of recommending position qualifications, according to an example embodiment.

FIG. 5 is a flow chart diagram illustrating another method of recommending position qualifications, according to an example embodiment.

FIG. 6 is a flow chart diagram illustrating another method of recommending position qualifications, according to another example embodiment.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The description that follows includes systems, methods, techniques, instruction sequences, and computing machine program products that embody illustrative embodiments of the inventive subject matter described in the present disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Example methods and systems are directed to recommending one or more qualifications for an available position. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one example embodiment, techniques for recommending position qualifications include receiving user input that identifies an available position, generating a set of qualifications for the available position by determining qualifications that are included in user profiles at an online social networking service that hold similar positions, and recommending the set of qualifications by transmitting the qualifications to the user.

In certain examples, an online social networking service may have been in existence for many years and collected significant amounts of data regarding members. In one example, the online social networking service is oriented around employment and professional connections and has access to many job postings, job descriptions, employment positions, and the like. For example, the online social networking service may be LinkedIn™.

Due to the data available to the online social networking system regarding current employment positions, qualifications, and the like, the system can extrapolate appropriate employment position qualifications using a position title and a location. In certain examples, the system matches one or more terms in a position title to determine qualifications for a new position posting. Due to the amount of available data, a user of the online social networking service would not be able to sort through to determine qualifications for a position.

In one example, a system receives a job title and a location for an available employment position. The system then retrieves one or more profiles at an online social networking service for users that are currently employed in positions that match the job title and location. The system may then recommend qualifications to the individual posting the available position using one or more qualifications from profiles of the currently employed persons.

A “position,” as described herein, includes an employment position at an employing entity, a volunteer position, or any other defined set of responsibilities within an organization. In certain examples, a position includes “Cashier,” “Salesman,” “Broker,” “Manager,” Executive Officer,” Engineer,” “Scientist,” “Paralegal,” “Secretary,” “Leader,” “Accountant,” “Engineer,” “Purchaser,” or the like.

In other examples, a position includes an industry, or other descriptors. For example, a position may include “Fast Food Cashier,” “Insurance Salesman,” “Mortgage Broker,” “Finance Manager,” “Chief Executive Officer,” “Chemical Engineer,” “Computer Scientist,” “Personal Secretary,” “Patent Paralegal,” “Team Leader,” “Chemical Engineer,” “Product Purchaser,” or the like.

In other examples, the position identifies an amount of experience. For example, a position may indicate “Senior Accountant,” “Entry Level Programmer,” or the like. In some example embodiments, various descriptors included in the title for a position indicate a specific number of years, as one skilled in the art may appreciate.

One benefit to using qualifications from currently employed persons is that the resulting description of the available position is more likely to include qualifications held by persons who would likely fill the available position.

Another benefit is that the recommended qualifications are more likely to include relevant skills, experience, education level, or the like, for the available position. Furthermore, by including qualifications from many other profiles for similarly skilled persons, a generated recommendation is more likely to include a comprehensive list of qualifications. A further benefit is that a user posting an available position need simply provide a job title and a location. In response, the system generates a list of qualifications that are appropriate for the available position.

In another example, as new technology emerges, persons in a related position may need to become familiar with the new technology. As employed people include this new technology in their profiles at the online social networking service, the system includes the new technology in the recommended list of qualifications.

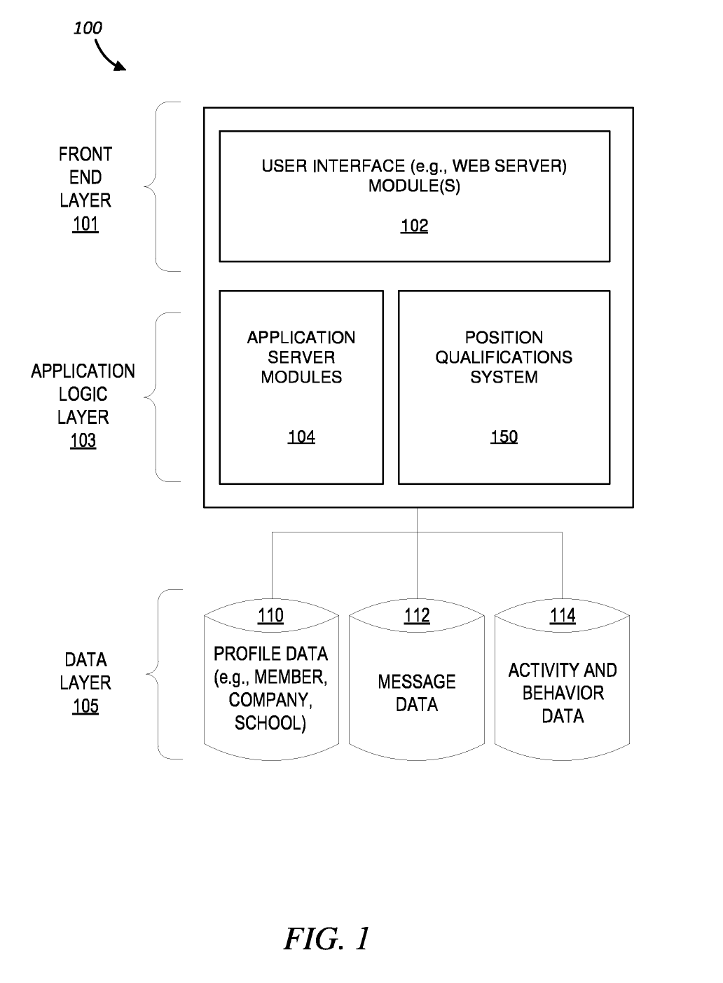

FIG. 1 is a block diagram illustrating various components or functional modules of an online social networking service 100, in an example embodiment. The online social networking service 100 may be utilized to generate a recommendation that includes qualifications for an available position. In one example, the online social networking service 100 includes a position qualifications system 150 that performs the various management operations described herein.

A front end layer 101 consists of one or more user interface modules (e.g., a web server) 102, which receive requests from various client computing devices and communicate appropriate responses to the requesting client devices. For example, the user interface module(s) 102 may receive requests in the form of Hypertext Transfer Protocol (HTTP) requests, or other web-based, application programming interface (API) requests. In another example, the front end layer 101 receives requests from an application executing via a member's mobile computing device. In one example, a member submits media content to be transmitted to other members of the online social networking service 100.

An application logic layer 103 includes various application server modules 104, which, in conjunction with the user interface module(s) 102, may generate various user interfaces (e.g., web pages, applications, etc.) with data retrieved from various data sources in a data layer 105.

In some examples, individual application server modules 104 may be used to implement the functionality associated with various services and features of the online social networking service 100. For instance, the ability of an organization to establish a presence in the social graph of the online social networking service 100, including the ability to establish a customized web page on behalf of an organization, and to publish messages or status updates on behalf of an organization, may be services implemented in independent application server modules 104. Similarly, a variety of other applications or services that are made available to members of the online social networking service 100 may be embodied in their own application server modules 104. Alternatively, various applications may be embodied in a single application server module 104.

In some examples, the online social networking service 100 includes the position qualifications system 150, which receives user input that identifies an available position, generates a set of qualifications for the available position by determining qualifications that are included in one or more user profiles at an online social networking service, and recommends the set of qualifications to be included in a description of the available position.

As illustrated, the data layer 105 includes, but is not necessarily limited to, several databases 110, 112, 114, such as a database 110 for storing profile data, including both member profile data and profile data for various organizations. In certain examples, the profile data includes the properties and/or characteristics of members of the online social networking service 100. Consistent with some examples, when a person initially registers to become a member of the online social networking service 100, the person may be prompted to provide some personal information, such as his or her name, age (e.g., birthdate), gender, sexual orientation, interests, hobbies, contact information, home town, address, spouse's and/or family members' names, educational background (e.g., schools, majors, matriculation and/or graduation dates, etc.), occupation, employment history, skills, religion, professional organizations, and other properties and/or characteristics of the member. This information is stored, for example, in the database 110. Similarly, when a representative of an organization initially registers the organization with the online social networking service 100, the representative may be prompted to provide certain information about the organization. This information may be stored, for example, in the database 110, or another database (not shown). In some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, education level, or seniority level within a particular company. In some examples, importing or otherwise accessing data from one or more externally hosted data sources may enhance profile data for both members and organizations. For instance, with companies in particular, financial data may be imported from one or more external data sources, and made part of a company's profile. In one example, the database 110 includes a user's education level, current position title, current position location, education level, position responsibilities, position field, or position industry, or other property of the user's position.

The online social networking service 100 may provide a broad range of other applications and services that allow members the opportunity to share and receive information, often customized to the interests of the member. For example, in some examples, the online social networking service 100 may include a message sharing application that allows members to upload and share messages with other members. In some examples, members may be able to self-organize into groups, or interest groups, organized around a subject or topic of interest. In some examples, the online social networking service 100 may host various job listings providing details of job openings within various organizations.

As members interact with the various applications, services, and content made available via the online social networking service 100, information concerning content items interacted with, such as by viewing, playing, and the like, may be monitored, and information concerning the interaction may be stored, for example, as indicated in FIG. 1 by the database 114. In one example embodiment, the interactions are in response to receiving a message requesting the interaction.

In one example embodiment, although a user may examine current employment positions, a user cannot practically examine the number of positions needed in order to extrapolate a set of qualifications. In certain examples, hundreds or thousands of current position descriptions are examined to determine a set of qualifications that are found in a majority of current position descriptions.

Although not shown, in some examples, the online social networking service 100 provides an API module via which third-party applications can access various services and data provided by the online social networking service 100. For example, using an API, a third-party application may provide a user interface and logic that enables the member to submit and/or configure a set of rules used by the position qualifications system 150. Such third-party applications may be browser-based applications, or may be operating system specific. In particular, some third-party applications may reside and execute on one or more mobile devices (e.g., phone or tablet computing devices) having a mobile operating system.

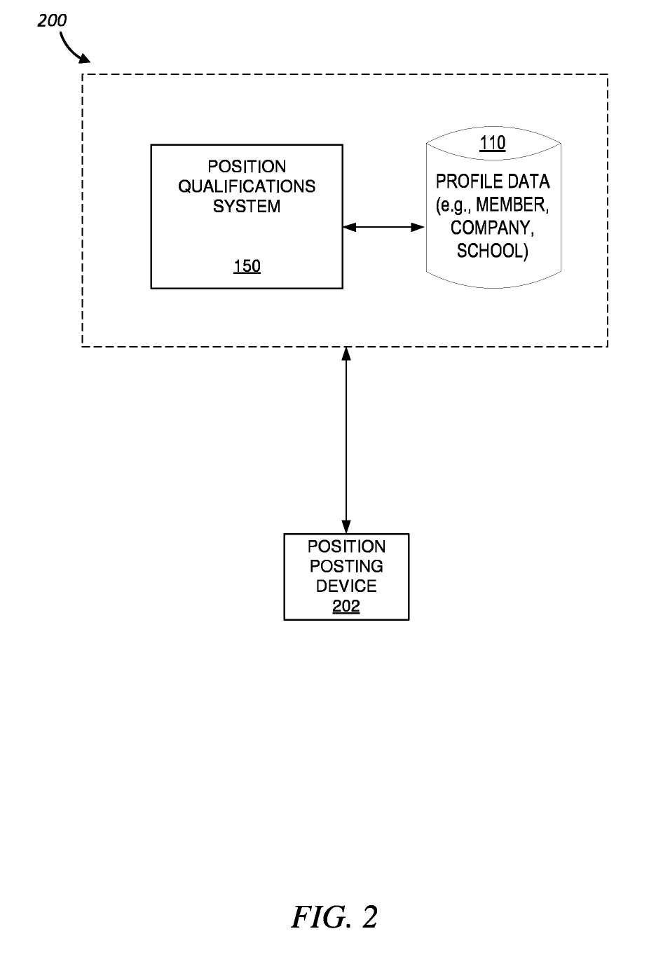

FIG. 2 is a block diagram illustrating a system 200 for recommending position qualifications, according to one example embodiment. In one example embodiment, the system 200 includes a position posting device 202, the position qualifications system 150, and the database 110.

In one example embodiment, a user uses the position posting device 202 to submit a position title and a location for an available position. Of course, the user may provide additional information, and this disclosure is not limited in this regard. In another example embodiment, the user directs the position qualifications system 150 to limit a number of qualifications to a threshold number. In one example, the threshold number of qualifications is 20, but of course, this is not necessarily the case.

In another example embodiment, the position qualifications system 150 removes generic qualifications from a set of qualifications. In one example, the position qualifications system 150 determines that one or more qualifications are generic in response to finding the qualifications in user profiles from a wide variety of different positions. In one example, in response to finding a qualification of “spreadsheet use” in more than five profiles for different positions, the position qualifications system 150 removes the “spreadsheet use” qualification from the set of qualifications.

In one example, spreadsheet use may be an essential skill for an entry level accountant, but spreadsheet use is also common to secretaries, engineers, and lots of other positions. Thus, including the requirement of “spreadsheet use” as a necessary skill doesn't necessarily increase the likelihood of drawing good, qualified candidates, but rather can increase the likelihood of drawing candidates that are not qualified. The system solves the problem of helping identify qualifications that are good discriminators and those that are not. Having access to such a large database of positions and their descriptions allows the system to determine which qualifications are generic and which ones are specific to the position.

In one example embodiment, the position qualifications system 150 also receives a size of the entity where the position is available and limits the profile search to those who are employed by similarly sized entities. In one example, the user (using the position posting device 202), indicates that the hiring entity is between 250 and 500 employees. In response, according to this embodiment, the position qualifications system 150 limits profile analysis to those persons who are currently employed by an entity having between 250 and 500 employees. In this way, the position qualifications system 150 generates qualifications that more likely represent what will be needed in the available position, since even similarly titled individuals often have differing responsibilities depending on the size of the company employing the individual.

In one example, a specific company size may not yield sufficient position descriptions. For example, limiting a search of comparable positions at the online social networking service may yield less than 10 current positions. In order to increase the number of comparable positions, in one example embodiment, the position qualifications system 150 may expand a company size. In one example, the position qualifications system 150 expands a company size by 10% increments until a threshold number of current job positions are received. In one example, the position qualifications system 150 expands a company size incrementally until at least 100 current comparable positions are found.

As an example of this, a human resources manager for a small company of 10 or fewer people may include different qualifications than a human resources manager for a large company of 10,000 or more employees. By focusing on similarly sized entities, the position qualifications system 150 determines more consistent qualifications for an available position. In one example, the human resources manager for the small company performs a wide variety of services whereas the human resources manager for the large company may specialize in a narrow field, such as, but not limited to, hiring, firing, benefits, or managing a team of human resources personnel.

In another example embodiment, the position qualifications system 150 receives an industry of the entity with the available position and the position qualifications system 150 restricts searching user profiles at the database 110 to those profiles representing persons employed by entities that operate in the industry. In one example, the industry is “computer gaming.” In response, the position qualifications system 150, in this example, searches for database 110 profiles for persons who are currently employed at a computer gaming entity.

In one example, a software engineer at an aerospace company may have different qualifications than a software engineer at a computer gaming company, and the position qualifications system 150 accounts for those differences by selecting profiles at the online social networking service 100 based on the industry of the available position.

In another example embodiment, the position qualifications system 150 requests that the user of the position posting device 202 either confirm or deny qualifications in the generated set of qualifications. In one example, the position qualifications system 150 transmits the set to the position posting device 202 for feedback from the user. In response, the user may confirm or deny one or more of the qualifications and the position posting device 202 may transmit the responses back to the position qualifications system 150.

In one example embodiment, the position posting device 202 is a specially programmed computer performing operations as described in the previous paragraphs. In another example, the position posting device 202 is a computer executing a web-based interface as one skilled in the art may appreciate. Certain examples include a personal computer, a desktop computer, a server, a mobile computing device such as a smart phone, a tablet, or the like. Of course, one skilled in the art may recognize other ways in which a user may interact with the position qualifications system 150 using a position posting device 202, and this disclosure is not limited in this regard.

In another example embodiment, the position qualifications system 150 stores the feedback from the user and adjusts subsequent sets of qualifications accordingly. In one example, the user (using the position posting device 202) indicates that a certain qualification is not desired for a given position. In response to a subsequent user indicating an available position that is similar, the position qualifications system 150 does not include the certain qualification. In this way, the position qualifications system 150 learns qualifications from persons posting available positions.

In one example embodiment, the position qualifications system 150 restricts profile retrieval to those profiles at the database 110 that are within a threshold range of experience indicated by the received title of the available position. In one example, the title of the available position includes “entry level.” In response, the position qualifications system 150 restricts profile retrieval to those profiles for persons who indicate an experience level of between zero and three years. In another example, in response to receive a position title that includes “Senior,” the position qualifications system 150 retrieves profiles from the database 110 for persons who indicate an experience level of more than 20 years. Of course, other values may be used, and this disclosure is not limited in this regard.

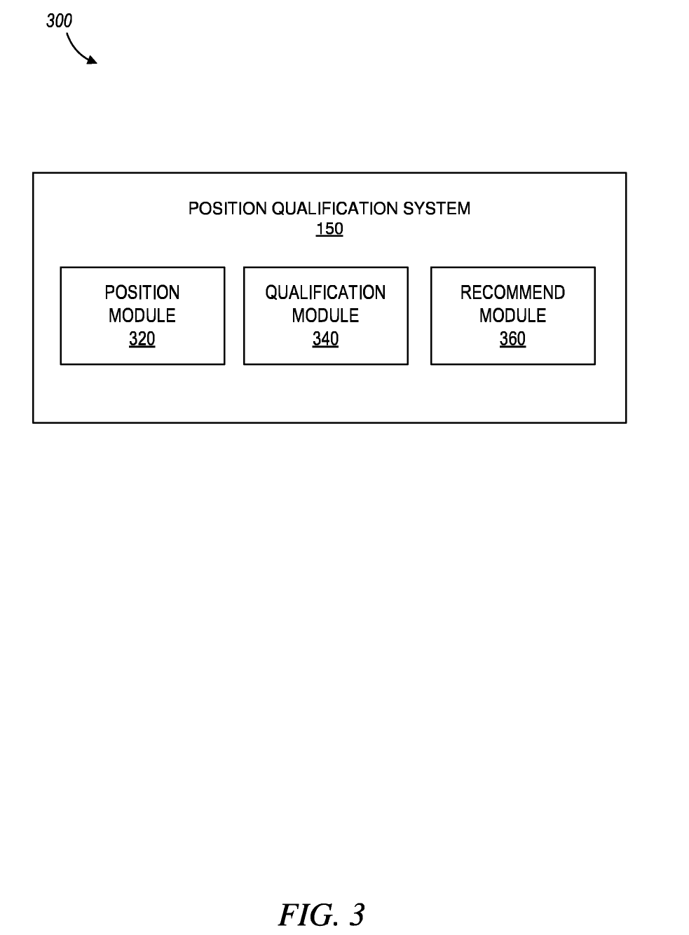

FIG. 3 is a block diagram illustrating another system 300 for recommending position qualifications, according to one example embodiment. In one example, the system 300 includes a position module 320, a qualification module 340, and a recommend module 360.

In one example embodiment, the position module 320 is configured to receive user input that identifies an available position. In one example, the user input includes a position title and a position location.

As one skilled in the art may appreciate, the title of the available position may include a wide variety of different terms. Certain examples includes, but are not limited to, “Entry Level Programmer,” “Engineering Manager,” “Chief Executive Officer,” “Senior Electrical Engineer,” “Human Resources Manager,” “Secretary,” “Experienced Sales Clerk,” or the like.

The position location, as described herein, includes a geographic location where the available position is located. The location may include a city, a county, a state, a country, a cultural region, or another geographic location.

In another example embodiment, the user input also includes a name of the entity providing the available position, a primary function of the available position, an industry for the available position, or other characteristics of the available position or the entity providing the available position.

In one example, the position module 320 asks the user of the position posting device 202 whether the user would like to receive a set of qualifications. In response to a positive response from the user, the position qualifications system 150 performs the various operations described herein to generate and recommend a set of qualifications for an available position.

In another example embodiment, the position module 320 receives the nature of the available position. In one example, the nature of the employment is selected from “temporary,” “on-call,” “part-time,” “full-time,” “contracted,” or the like. In response, the qualification module 340 retrieves profiles from the database 110 that match the nature of the available position.

In one example embodiment, the position module 320 also receives the identity of the entity providing the available position. In this example embodiment, the qualification module 340 limits the retrieval of profiles from the database 110 to those profiles that are for persons employed by entities of a similar size, as previously described.

In another example embodiment, the position module 320 receives the industry for the available position. In certain non-limiting examples, the industry is one of software, manufacturing, engineering, management, financial, legal, transportation, medical, textile, digital services, food services, sales, shipping services, sports, waste management, or other, or the like.

In one example embodiment, the qualification module 340 is configured to generate a set of qualifications for the available position by determining qualifications that are included in one or more user profiles at the online social networking service 100. According to this example embodiment, the user profiles are for persons who currently hold a position at the location and similar to the available position.

In one example embodiment, the similarity between the available position and the held positions is based on similar terms in titles for the positions. In one example, where the available position includes “Ophthalmologist” and held positions include “Ophthalmologist,” the position qualification system 150 may determine that the positions are similar.

In other examples, similarity is based on similar terms, and a similar size of an employer. In another example, similarly is based on a same employer. In one example, an available position at Company A may be titled “Computer Scientist Level 4” and the position qualification system searches the database 110 for currently held positions at Company A titled “Computer Scientist Level 4.”

In another example, similarity is based on similar terms in a title and a same location. In one example, where the available position includes “Information Technology Manager” and is located in Texas, the position qualification system 150 may search for other currently held positions with “Information Technology Manager” in the title and are located in Texas.

In one example, seniority is indicated by the title of the available position. For example, where a title of the available position includes “Senior Contract Negotiator,” the qualification module 340 determines that the experience level for the available position is 15 years or more. In another example, the title of the available position includes “Apprentice,” and the qualification module 340 determines that the experience level for the position is between zero and five years.

In another example embodiment, in response to the title of the available position not indicating an experience level, the position module 320 requests the experience level from the user.

In one example embodiment, the qualification module 340 limits qualifications to a threshold number. In one example, a threshold number of qualifications is 20 and the qualification module 340 determines the 20 qualifications that are most frequently included in profiles for similar positions stored in the database 110. Of course, other values may be used, and this disclosure is not limited in this regard. In another example embodiment, the position module 320 receives the threshold number of qualifications from the user.

In one example embodiment, the qualification module 340 removes generic qualifications from the set of qualifications. In one example, the threshold number of qualifications does not include generic qualifications. In another example embodiment, the qualification module 340 determines that qualifications are generic in response to the qualification being included in profiles for different positions in different industries.

In one example, the qualification module 340 determines whether identified qualifications are generic. Generic qualifications are those that span across different profiles for different positions, industries, and/or experience levels. As a general rule, generic qualifications are not good discriminators in drawing appropriate candidates to the hiring pool as they may be skills that are held by numerous individuals in a variety of job positions, industries, experience levels and/or so forth. As one representative example, the system identifies a “Word Processing” qualification is included in many different profiles for different positions, industries, and/or experience levels. In response, the qualification module 340 removes “Word Processing” from a generated set of qualifications because the qualification is “generic.”

In another example embodiment, the qualification module 340 presents the set of qualifications to the user and requests that the user indicate whether the qualifications are appropriate or not. In response to a user indicating that one or more qualifications are not appropriate for the available position, the qualification module stores the indicator. In response to receiving a subsequent available position with a similar title, the qualification module 340 does not included the qualification although the qualification may be included in similar positions stored in profiles in the database 110. Therefore, the generated set of qualifications may also be, at least partially, based on indications from a user.

In one example embodiment, the qualification module 340 limits retrieval of profiles at the database 110 to those profiles representing persons with similar ranges of experience. In one example, the available position includes “Manager,” and the qualification module 340 limits retrieval of profiles at the database 110 to those profiles that include “Manager.”

In one example embodiment, the qualification module 340 determines profiles at the database 110 for persons that currently hold positions similar to the available position. In one example, the qualification module 340 first considers currently held positions at the entity providing the available position. For example, the qualification module 340 transmits a query to the database 110 to select member profiles for members that currently hold a position with like terms in the position title.

According to this example embodiment, in response to there being insufficient qualifications, the qualification module 340 may consider the location of the available position at the providing entity. In one example, the qualification module 340 limits retrieval of profiles at the database 110 to those profiles representing persons currently employed at the location.

In response to there still being insufficient qualifications, the qualification module 340 may then expand retrieval of profiles to profiles representing persons currently employed in a similar position with an entity that is similar to the entity providing the available position. In one example embodiment, the qualification module 340 limits retrieval of profiles to profiles representing persons currently employed in a similar industry to the entity providing the available position.

In one example embodiment, the qualification module 340 determines educational degree and field of study pairs. The qualification module 340 may then include the most prevalent degree and field of study as a qualification for the available position. After determining the most prevalent degree and field of study, the qualification module 340 may then determine an expected number of years of experience based on the median and/or standard deviation for number of years of experience of the profiles retrieved from the database 110.

As one skilled in the art may appreciate, a certain position at a large corporation may vary widely as compared with a similar position at a start-up corporation. In one example, a Vice-President of Finance for a start-up corporation may still include substantially keeping the financial records of the corporation, whereas the Vice-President of Finance for a larger corporation may substantially include management responsibility for a team of accountants. Therefore, because the qualification module 340 may limit retrieval of profiles at the database 110 to currently held positions at similarly sized entities, the qualification module 340 is more likely to generate an accurate set of responsibilities and corresponding qualifications for an available position.

In another example, a Vice President of a banking entity may vary from a Vice President of a software company. Therefore, in other examples, because the qualification module 340 may limit selection of profiles to those in a similar industry to the available position, the qualification module 340 is more likely generate a set of qualifications for an available position by limiting selection of profiles from the database 110 to those profiles that are associated with currently held positions in the same industry as the entity providing the available position.

In another example, as the employment industry begins using new position titles, the qualification module 340 determines qualifications for a similar available position based, at least in part, on qualifications for persons currently holding a similar position and having a profile at the online social networking service 100. In this way, the qualification module 340 quickly generates sets of qualifications for the new position without requiring a user to provide a comprehensive list of qualifications.

In another example embodiment, in response to receiving an available position from a user that includes a new position title for the available position, the qualification module 340 determines a set of most recently added qualifications and generates the set of qualifications based on this set of most recently added qualifications.

In another example embodiment, the qualification module 340 generates language for one or more of the qualifications. In one example, in response to determining an appropriate educational level for the available position, the qualification module 340 may generate language describing the educational level.

In one example, the qualification module 340 generates language substantially similar to, “This position requires at least a M.S. Degree in Computer Science and 5 or more years of experience. Furthermore, the position requires the following skills: C, C++, C#, PHP, Perl, . . . .” In another example, the qualification module 340 allows the user to modify the generated language.

In another example embodiment, the recommend module 360 is configured to recommend the set of qualifications to be included in a description of the available position. The recommend module 360 may transmit the set of qualifications or a textual description of the qualifications to the user via the position posting device 202, or another device, as one skilled in the art may appreciate.

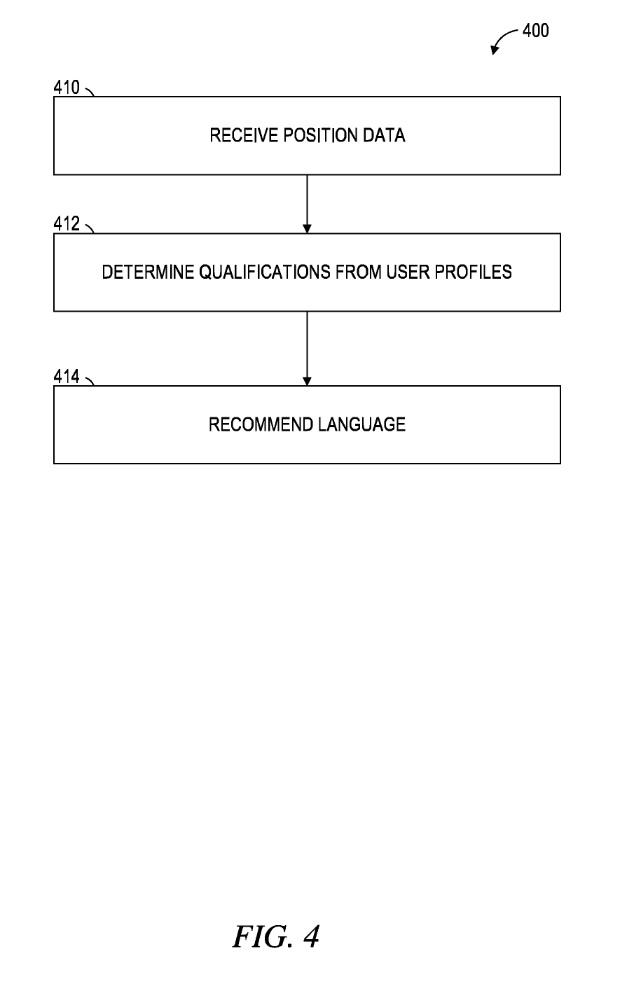

FIG. 4 is a flow chart diagram illustrating a method 400 of recommending position qualifications, according to an example embodiment. According to one example embodiment, the method 400 is performed by one or more modules of the position qualifications system 150 and is described by way of reference thereto.

In one embodiment, the method 400 begins and at operation 410 the position module 320 receives user input that identifies an available position. In one specific example, the position module 320 receives a title of the available position and a location of the available position. In other embodiments, the position module 320 receives other properties of the available position, such as, but not limited to, identification of the entity providing the available position, size of the entity, field, industry, nature, compensation, associated benefits, or the like.

The method 400 continues at operation 412 and the qualification module 340 generates a set of qualifications for the available position. In one example, the qualification module 340 determines qualifications that are included in one or more user profiles at the online social networking service 100. In another example, the respective user profiles at the database 110 are for persons who currently hold a position having a similar title to the available position and located at the location of the available position.

In one specific, non-limiting example, the qualification module 340 constructs a database query and transmits the query to the profile database 110. In response, the qualification module 340 receives results of the query. In certain examples, the query results includes hundreds, thousands, or millions of profiles. In another example embodiment, the qualification module 340 parses the profiles into strings resulting in a set of strings and a number of times the string appeared in the search result profiles.

The qualification module 340 may then remove strings that are generic strings leaving strings found in the search results that include qualifications. The qualification module 340 then, in one example embodiment, ranks the remaining strings according to a number of times the string was found in the profiles. In one example, the ranked strings are the most prevalent qualifications and are included in the determined set of qualifications.

The method 400 continues at operation 414 and the recommend module 360 recommends the set of qualifications to be included in a description of the available position. In one example, the recommend module 360 causes the set of qualifications to be displayed to the user by transmitting a message to a computing device being used by the user. In one example, the computing device is the position posting device 202. In another example, the recommend module 360 communication with an application executing on the position posting device 202.

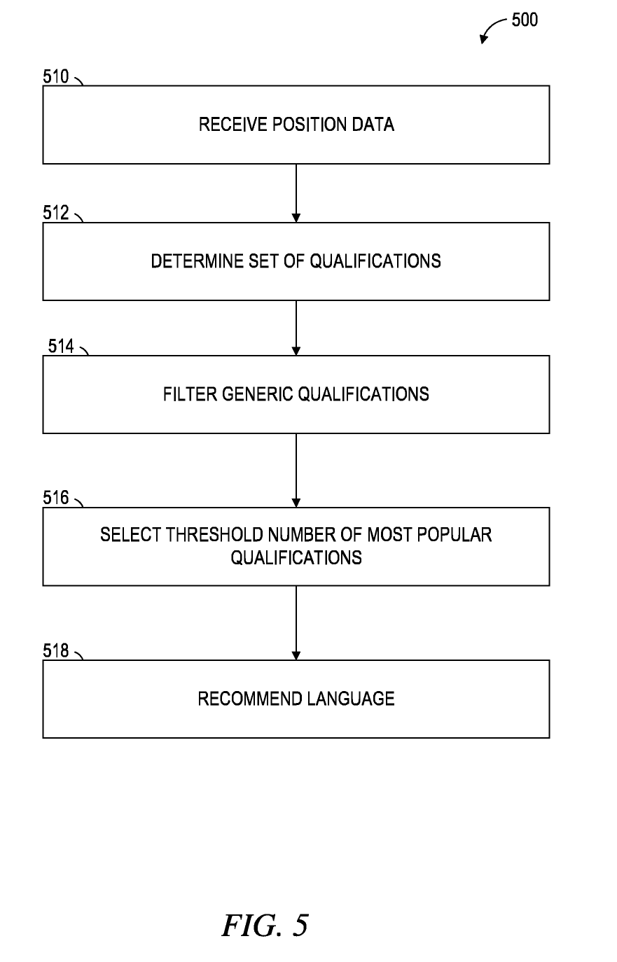

FIG. 5 is a flow chart diagram illustrating another method 500 of recommending position qualifications, according to an example embodiment. According to one example embodiment, the method 500 is performed by one or more modules of the position qualifications system 150 and is described by way of reference thereto.

In one embodiment, the method 500 begins and at operation 510 the position module 320 receives user input that identifies an available position, as described herein. In one specific example, the position module 320 receives the identity of the entity providing the available position, a title of the available position, and a location of the available position.

The method 500 continues at operation 512 and the qualification module 340 generates a set of qualifications for the available positions. In one example, the qualification module 340 determines qualifications that are included in user profiles located at the database 110 and for persons who currently hold a position similar to the available position. In another example, the qualification module 340 determines qualifications by determining whether a threshold number of similar positions include the qualifications. In one example, in response to five or more profiles for similarly held positions and stored in the database 110 including a qualification, the qualification module 340 determines that the qualification should be included in the set of qualifications.

The method 500 continues at operation 514 and the qualification module 340 filters the set of qualifications to remove generic qualifications. In one example, the qualification module 340 determines that qualifications are “generic” in response to finding the qualification in profiles for currently held positions in other industries and/or for other position titles. In this example, in response to determining that certain qualifications are “generic,” the qualification module 340 removes the qualifications from the set of qualifications. In this way, the set of qualifications may be restricted to those qualifications that are unique to the specific available position.

The method 500 continues at operation 516 and the qualification module 340 selects a threshold number of qualifications from the set of qualifications. In one example, the qualification module 340 orders the qualifications in the set according to a count of profiles at the database 110 that include each qualification. The qualification module 340, in this example, then selects the top threshold number of qualifications. In one example, the threshold number of qualification is ten, but of course, this is not necessarily the case.

The method 500 continues at operation 518 and the recommend module 360 recommends the set of qualifications to be included in a description of the available position.

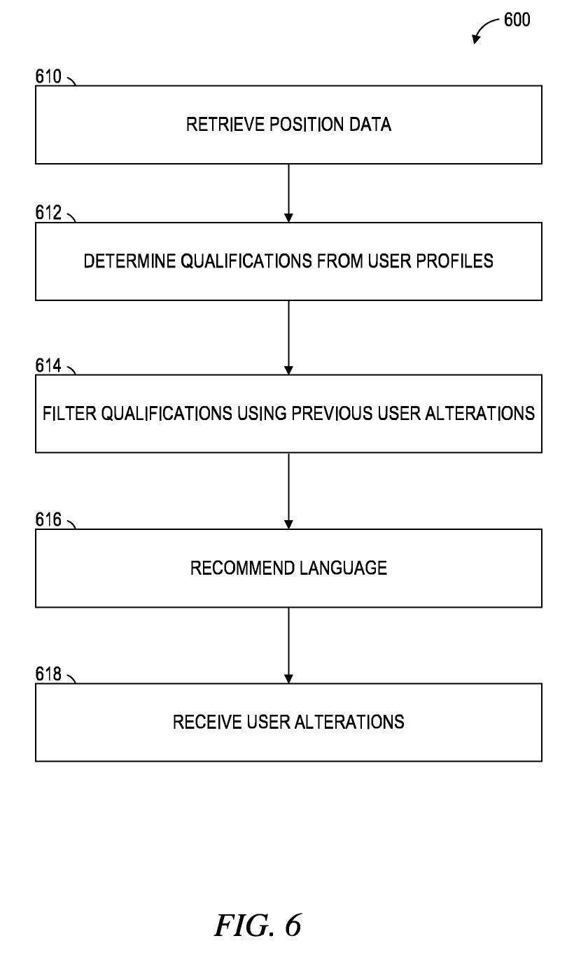

FIG. 6 is a flow chart diagram illustrating a method 600 of recommending position qualifications, according to another example embodiment. According to one example embodiment, the method 600 is performed by one or more modules of the position qualifications system 150 and is described by way of reference thereto.

In one embodiment, the method 600 begins and at operation 610 the position module 320 retrieves user input that identifies an available position. The method 600 continues at operation 612 and the qualification module 340 generates a set of qualifications for the available position in any way as described herein. In one example, the qualification module 340 retrieves qualifications from member profiles at the social networking service 100 as described herein. For example, from database 110.

The method 600 continues at operation 614 and the qualification module 340 filters the set of qualifications based on user alterations to a previous set of qualifications for a similar available position. In one example, a previous available position was a “Secretary” for a small corporation, and a previous user indicated that the qualification of “Associate's Degree” was not a qualification. In response to a current available position being for a “Secretary” for a small corporation, and the qualification module 340 determining that an Associate's Degree is a qualification, the qualification module 340 removes the qualification from the set of qualifications based on the previous user's indication.

The method 600 continues at operation 616 and the recommend module 360 recommends the set of qualifications to be included in a description of the available position. In one example, the recommend module 360 displays the set of qualifications via a graphical user interface.

The method 600 continues and at operation 618 the qualification module 340 receives additional indications from the user. In one example, the user indicates whether qualifications in the set should or should not be included in the description for the available position by manipulating a user interface either at the qualification module 340 or at the position posting device 202. In another example, the qualification module 340 receives a message from the user indicating whether one or more qualifications are to be included in the description for the available position.

In another example embodiment, the qualification module 340 receives additional qualifications from the user to be included in the description of the available position. In one example, the qualification module 340 stores the additional qualification to be included in descriptions of subsequent available positions with a similar title and location.

In this way, the qualification module 340 includes the additional qualification in a set of qualifications for a subsequent available position based on the user input, although the qualification may not appear in various user profiles in the database 110 for persons holding similar positions.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-6 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Example Machine Architecture and Machine-Readable Medium

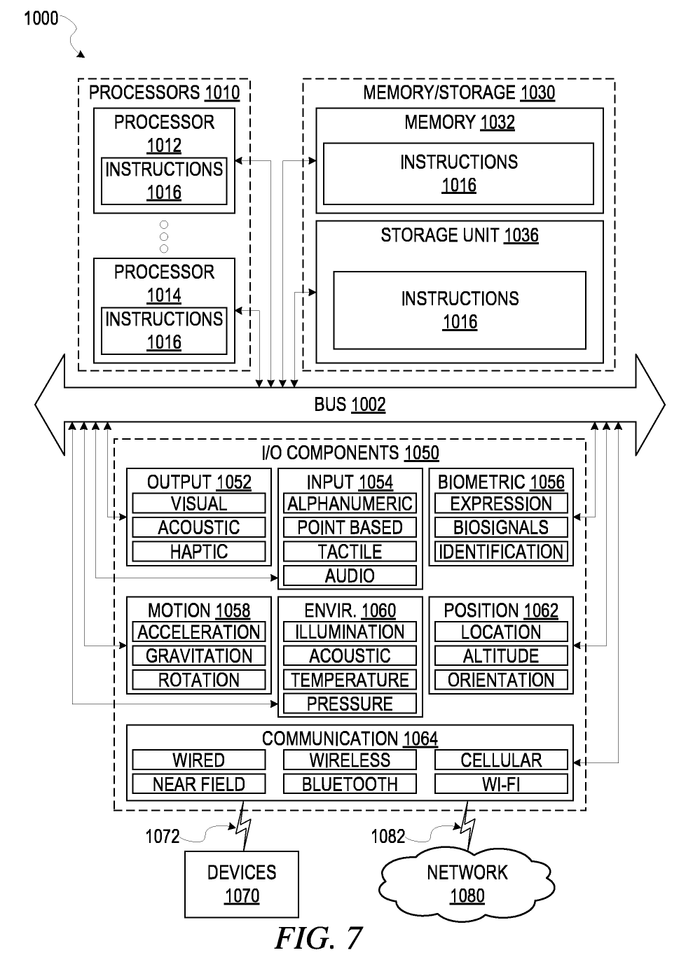

FIG. 7 is a block diagram illustrating components of a machine 1000, according to some example embodiments, able to read instructions from a machine-readable medium (e.g., a machine-readable storage medium) and perform any one or more of the methodologies discussed herein

Specifically, FIG. 7 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example, the instructions may cause the machine to execute the flow diagrams of FIGS. 4-6. Additionally, or alternatively, the instructions may implement one or more of the components of FIG. 3. The instructions transform the general, non-programmed machine into a particular machine programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a personal digital assistant (PDA), or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory/storage 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1012 and a processor 1014 that may execute the instructions 1016. The term “processor” is intended to include multi-core processors that may comprise two or more independent processors (sometimes referred to as “cores”) that may execute instructions contemporaneously. Although FIG. 7 shows multiple processors, the machine 1000 may include a single processor with a single core, a single processor with multiple cores (e.g., a multi-core processor), multiple processors with a single core, multiple processors with multiples cores, or any combination thereof.

The memory/storage 1030 may include a memory 1032, such as a main memory, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 may also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of the processors 1010 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 7. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062 among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1062 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via a coupling 1082 and a coupling 1072 respectively. For example, the communication components 1064 may include a network interface component or other suitable device to interface with the network 1080. In further examples, the communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a Universal Serial Bus (USB)).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 1080 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting-organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 may be transmitted or received using a transmission medium via the coupling 1072 (e.g., a peer-to-peer coupling) to the devices 1070. The term “transmission medium” shall be taken to include any intangible medium that is capable of storing, encoding, or carrying the instructions 1016 for execution by the machine 1000, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a machine-readable medium having instructions stored thereon, which, when executed by a processor, cause the system to:
receive user input that identifies an available position, the user input comprising a position title and a location;
generate a set of qualifications for the available position by determining qualifications that are included in one or more user profiles at an online social networking service, the user profiles for persons who currently hold a position at the location and similar to the available position; and
recommend the set of qualifications to be included in a description of the available position.

2. The system of claim 1, wherein the instructions further cause the system to limit the set of qualifications to a threshold number of qualifications.

3. The system of claim 1, wherein the instructions further cause the system to remove generic qualifications from the set of qualifications.

4. The system of claim 1, wherein the user input further includes an entity offering the available position, the persons limited to persons who hold current positions with entities that are similar in size to the entity.

5. The system of claim 1, wherein the user input further includes an industry for the available position, the persons limited to persons who hold a position with an entity in the industry.

6. The system of claim 1, wherein the instructions further cause the system to either add or remove one or more qualifications to or from the set of qualifications in response to a user selection, the system generating subsequent sets of qualifications using the user selection.

7. The system of claim 1, wherein the user profiles are limited to user profiles that include a threshold range of experience indicated by the position title.

8. A method comprising:
receiving user input that identifies an available position, the user input comprising a position title and a location;
generating a set of qualifications for the available position by determining qualifications that are included in one or more user profiles at an online social networking service, the user profiles for persons who currently hold a position at the location and similar to the available position; and
recommending the set of qualifications to be included in a description of the available position.

9. The method of claim 8, further comprising limiting the set of qualifications to a threshold number of qualifications.

10. The method of claim 8, further comprising removing generic qualifications from the set of qualifications.

11. The method of claim 8, wherein the user input further includes an entity offering the available position, the persons limited to persons who hold current positions with entities that are similar in size to the entity.

12. The method of claim 8, wherein the user input further includes an industry for the available position, the persons limited to persons who hold a position with an entity in the industry.

13. The method of claim 8, further comprising either adding or removing one or more qualifications to or from the set of qualifications in response to a user selection, and wherein generating subsequent sets of qualifications comprises generating subsequent sets of qualifications using the user selection.

14. The method of claim 8, wherein the user profiles are limited to user profiles that include a threshold range of experience indicated by the position title.

15. A non-transitory machine-readable medium having instructions stored thereon, which, when executed by a processor, cause the processor to perform operations comprising:
receiving user input that identifies an available position, the user input comprising a position title and a location;
generating a set of qualifications for the available position by determining qualifications that are included in one or more user profiles at an online social networking service, the user profiles for persons who currently hold a position at the location and similar to the available position; and
recommending the set of qualifications to be included in a description of the available position.

16. The non-transitory machine-readable medium of claim 15, wherein the instructions further cause the processor to limit the set of qualifications to a threshold number of qualifications.

17. The non-transitory machine-readable medium of claim 15, wherein the instructions further cause the processor to remove generic qualifications from the set of qualifications.

18. The non-transitory machine-readable medium of claim 15, wherein the user input further includes an entity offering the available position, and the persons are limited to persons who hold current positions with entities that are similar in size to the entity.

19. The non-transitory machine-readable medium of claim 15, wherein the user input further includes an industry for the available position, the persons limited to persons who hold a position with an entity in the industry.

20. The non-transitory machine-readable medium of claim 15, wherein the instructions further cause the processor to either add or remove one or more qualifications to or from the set of qualifications in response to a user selection, and wherein generating subsequent sets of qualifications comprises generating subsequent sets of qualifications using the user selection.
